(19) United States
(12) Patent Application Publication
(10) Pub. No.: US 2026/0159769 A1
(43) Pub. Date: Jun. 11, 2026

(54) PROCESS FOR UPGRADING FISCHER-TROPSCH OIL TO SYNTHETIC PARAFFINIC KEROSENE

(71) Applicant: UOP LLC, Des Plaines, IL (US)

(72) Inventors: Krishan Pratap Jadaun, Rajasthan (IN); John A. Petri, Wauconda, IL (US); Richa Sharma, Haryana (IN)

(21) Appl. No.: 19/320,250

(22) Filed: Sep. 5, 2025

Related U.S. Application Data
(60) Provisional application No. 63/728,778, filed on Dec. 6, 2024.

(51) Int. Cl. C10G 67/02; B01J 29/74

(52) U.S. Cl. CPC C10G 67/02; B01J 29/7415; B01J 29/7461; C10G 2300/1022; C10G 2400/08

(57) ABSTRACT

Processes for converting Fischer-Tropsch products into synthetic paraffinic kerosene which can be used to make aviation. The process schemes provide the possibility of different degrees of isomerization of an unconverted oil recycle to maximize the distillate yields. Different process schemes can be employed depending on the type of Fischer-Tropsch feed, e.g., the distillate to wax ratio in the Fischer-Tropsch oil. The present invention provides routes to produce sustainable aviation fuel (SAF) from a Fischer-Tropsch complex with a lower level of isomerization leading to better SAF yields.

### RELATED APPLICATIONS

This application claims priority to U.S. Provisional Patent Application Ser. No. 63/728,778, filed on Dec. 6, 2024, the entirety of which is incorporated herein by reference.

### BACKGROUND

Fischer-Tropsch synthesis is known to yield a broad mixture of products including primarily paraffins, and some olefins. The individual compounds of such mixture can contain up to about 200 carbons. Typically, the number of carbons is between about 20 and about 150, with an average number of carbons of about 60. Some Fischer-Tropsch processes yield mixtures enriched with C₅-C₃₀ alkanes containing a significant quantity of olefins and oxygenated compounds, such as alcohols or acids. Trace amounts of sulfur-containing or nitrogen-containing products or aromatic compounds can be also present. Fischer-Tropsch products can be divided into light oils with carbon number 5-16, heavy oils with carbon numbers 7-26, and waxes with carbon numbers 12-100. Fischer-Tropsch liquids are frequently used as a raw material for obtaining various fuel and chemical products, such as, e.g., distillates such as kerosene or diesel fuels, solvents and waxes for food processing among others.

In some existing processes, the Fischer-Tropsch feed is hydrocracked, isomerized, and separated into one or more product streams. The unconverted oil stream from the separation is recycled to the hydrocracking reaction zone, resulting in it being highly isomerized due to multiple passes over the isomerization catalyst. While isomerization provides better activity, it also results in lower selectivity to distillates.

Therefore, there is a need for improved processes for converting Fischer-Tropsch liquids and waxes into transportation fuels.

### BRIEF DESCRIPTION OF THE DRAWINGS

FIG. 1 is an illustration of one embodiment of a process for converting a Fischer-Tropsch product into aviation fuel.

FIG. 2 is an illustration of another embodiment of a process for converting a Fischer-Tropsch product into aviation fuel.

### DESCRIPTION

The present invention meets this need by providing processes for converting Fischer-Tropsch products into aviation fuel. Low carbon intensive sustainable aviation fuels reduce aviation green house gas emissions and would help to minimize dependence on fossil fuel. As petroleum based jet fuel is replaced with renewable sources of fuel, the present invention would be instrumental in helping to supplement the future supply of sustainable aviation fuel. The degree of isomerization has a great impact on cracking activity and selectivity. The present invention provides routes to produce synthetic paraffinic kerosene from a Fischer-Tropsch complex with a lower level of isomerization leading to better yields. The synthetic paraffinic kerosene can be turned into sustainable aviation fuel (SAF). The process schemes provide the possibility of different degrees of isomerization of an unconverted oil recycle to maximize the distillate yields. Different process schemes can be employed depending on the type of Fischer-Tropsch feed, e.g., the distillate to wax ratio in the Fischer-Tropsch oil. In addition, Fischer-Tropsch liquids and waxes can be synthesized from biomass as a renewable resource, which provides a lower carbon intensity advantage over petroleum-based products.

One aspect of the invention is a process for upgrading Fischer-Tropsch oil to synthetic paraffinic kerosene. In one embodiment, the process comprises providing a Fischer-Tropsch product stream comprising C₈₊ normal paraffins. The Fischer-Tropsch product stream is hydrocracked in a hydrocracking reaction zone comprising a hydrocracking reactor in the presence of a hydrocracking catalyst under hydrocracking conditions to form a hydrocracked effluent stream. The hydrocracked effluent stream is separated in a product recovery zone into at least a kerosene stream comprising C₈ to C₂₀ isoparaffins and normal paraffins, and an unconverted oil stream comprising C₁₉₊ hydrocarbons. The kerosene stream is dewaxed in a dewaxing reaction zone comprising a dewaxing reactor in the presence of a dewaxing catalyst under dewaxing conditions to form a Fischer-Tropsch synthetic paraffinic kerosene stream comprising C₈ to C₂₀ normal paraffins and isoparaffins.

In some embodiments, the process further comprises recycling the unconverted oil stream to the hydrocracking reaction zone.

In some embodiments, separating the hydrocracked stream comprises separating the hydrocracked stream into at least the kerosene stream, the unconverted oil stream, and a naphtha stream comprising C₈₋ normal paraffins and isoparaffins, or a fuel gas stream comprising fuel gas and liquified petroleum gas, or a hydrogen stream, or combinations thereof.

In some embodiments, the process further comprises passing a hydrogen gas stream to the dewaxing reaction zone or the hydocracking reaction zone or both.

In some embodiments, the hydrogen gas stream comprises a recycle hydrogen stream from the product recovery zone.

In some embodiments, the hydrocracking catalyst comprises an amorphous acidic component. In some embodiments, the amorphous acidic component comprises an amorphous silica-alumina.

In some embodiments, the hydrocracking catalyst comprises a noble metal.

In some embodiments, the dewaxing reaction conditions comprise a temperature in a range of 315° C. to 400° C., or a hydrogen partial pressure in a range of 300 psig to 1000 psig, or both; or the dewaxing catalyst comprises a molecular sieve of AEL or MRE framework with a noble metal; or both.

In some embodiments, the hydrocracking reaction conditions comprise a temperature in a range of 315° C. to 415° C., or a pressure in a range of 300 to 1000 psig, or both; or the hydrocracking catalyst comprises Y zeolite, beta zeolite, amorphoussilica-alumina, noble metals, base metals, or combinations thereof, or both.

In some embodiments, providing the Fischer-Tropsch product stream comprises reacting synthesis gas comprising hydrogen and carbon monoxide or carbon dioxide or both in a Fischer-Tropsch reaction zone comprising a Fischer-Tropsch reactor in the presence of a Fischer-Tropsch catalyst under Fischer-Tropsch reaction conditions to form the Fischer-Tropsch product stream.

In some embodiments, the Fischer-Tropsch reaction conditions comprise a temperature in a range of 150° C. to 300° C., or a pressure in a range of 200 to 750 psig, or both; or the Fischer-Tropsch catalyst comprises a Fe-, Co-, Ni-, Ru-based catalyst or combinations thereof, or both.

Another aspect of the invention is a process for upgrading Fischer-Tropsch oil to synthetic paraffinic kerosene. In one embodiment, the process comprises providing a Fischer-Tropsch product stream comprising C₈₊ normal paraffins. The Fischer-Tropsch product stream is dewaxing in a dewaxing reaction zone comprising a dewaxing reactor in the presence of a dewaxing catalyst under dewaxing conditions to form a dewaxed effluent stream comprising C₈₊ normal paraffins and isoparaffins. The dewaxed effluent stream and a hydrocracked effluent stream are separated in a product recovery zone into at least a kerosene stream comprising C₈ to C₂₀ normal paraffins and isoparaffins, and an unconverted oil stream comprising C₁₉₊ hydrocarbons. The unconverted oil stream is hydrocracked in a hydrocracking reaction zone comprising a hydrocracking reactor in the presence of a hydrocracking catalyst under hydrocracking conditions to form the hydrocracked effluent stream comprising C₈₊ normal paraffins and isoparaffins. The hydrocracked effluent stream is passed to the product recovery zone.

In some embodiments, separating the dewaxed effluent stream and the hydrocracked effluent stream into at least the kerosene stream and the unconverted oil stream comprises separating the dewaxed effluent stream and the hydrocracked effluent stream in the product recovery zone into at least the kerosene stream, the unconverted oil stream, and a naphtha stream comprising C₈₋ normal paraffins and isoparaffins, or a fuel gas stream comprising fuel gas and liquefied petroleum gas, or a hydrogen stream, or combinations thereof.

In some embodiments, the process further comprises passing a hydrogen gas stream to the dewaxing reaction zone or the hydrocracking reaction zone or both.

In some embodiments, the hydrogen gas stream comprises a recycle hydrogen stream from the product recovery zone.

In some embodiments, the hydrocracking catalyst comprises an amorphous acidic component. In some embodiments, the amorphous acidic component comprises an amorphous silica-alumina.

In some embodiments, the hydrocracking catalyst comprises a noble metal.

In some embodiments, the dewaxing reaction conditions comprise a temperature in a range of 315° C. to 400° C., or a hydrogen partial pressure in a range of 300 psig to 1000 psig, or both; or the dewaxing catalyst comprises a molecular sieve of AEL or MRE framework with a noble metal; or both.

In some embodiments, the hydrocracking reaction conditions comprise a temperature in a range of 315° C. to 415° C., or a pressure in a range of 300 to 1000 psig, or both; or the hydrocracking catalyst comprises Y zeolite, beta zeolite, amorphous silica-alumina, noble metals, base metals, or combinations thereof, or both.

In some embodiments, providing the Fischer-Tropsch product stream comprises reacting synthesis gas comprising hydrogen and carbon monoxide or carbon dioxide or both in a Fischer-Tropsch reaction zone comprising a Fischer-Tropsch reactor in the presence of a Fischer-Tropsch catalyst under Fischer-Tropsch reaction conditions to form the Fischer-Tropsch product stream.

In some embodiments, the Fischer-Tropsch reaction conditions comprise a temperature in a range of 150° C. to 300° C., or a pressure in a range of 200 to 750 psig, or both; or the Fischer-Tropsch catalyst comprises a Fe-, Co-, Ni-, Ru-based catalyst or combinations thereof, or both.

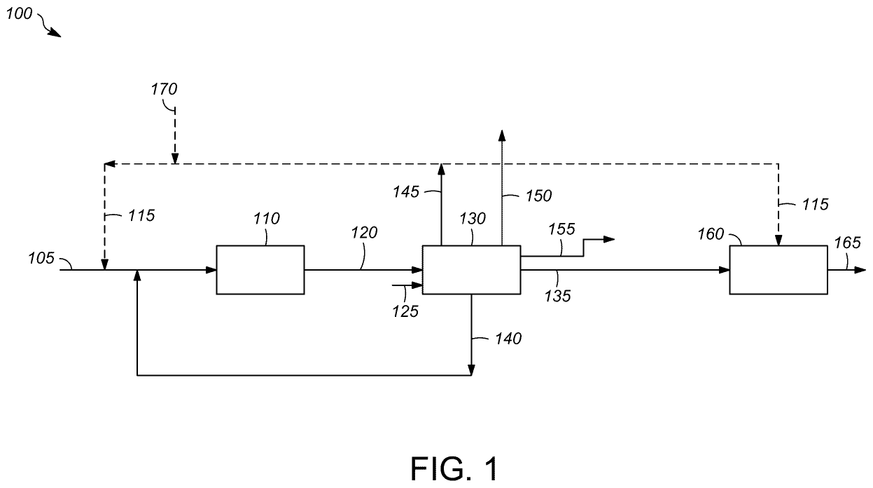

FIG. 1 illustrates a process 100 for upgrading Fischer-Tropsch oil to sustainable aviation fuel. The Fischer-Tropsch product stream 105 comprising C₈₊ normal paraffins is sent to the hydrocracking reaction zone 110 along with a hydrogen recycle stream 115 where the C₈₊ normal paraffins are hydrocracked to C₃ to C₂₀ normal paraffins and isoparaffins.

The hydrocracking reaction zone 110 has multiple beds to manage the temperature rise. The hydrocracking reaction zone 110 comprises one or more hydrocracking reactors, and each hydrocracking reactor can have one or more beds. A single hydrocracking reactor would have more than one bed. If there are two or more hydrocracking reactors, each reactor could have a single bed or multiple beds.

The hydrocracking reaction zone includes a hydrocracking catalyst. Any hydrocracking catalyst suitable for hydrocracking the Fischer-Tropsch feed can be used. The hydrocracking catalyst may comprise an acidic component, including, but not limited to, an amorphous acidic component such as amorphous silica-alumina (ASA). The hydrocracking catalyst may comprise a noble metal. Noble metals include, but are not limited to, Au, Ag, Pt, Pd, Ru, Rh, Pd, Os, and Ir. One suitable hydrocracking catalyst comprises a noble metal and ASA which provides high middle distillate selectivity. It is a good choice if the Fischer-Tropsch product stream does not contain significant concentrations of hetero-atomic components containing sulfur or nitrogen. In another embodiment, a suitable hydrocracking catalyst comprises a noble metal and crystalline acidic components such as a faujasite-based ultra-stable Y-zeolite and a beta zeolite. Typically, Fischer-Tropsch product stream does not contain sulfur or nitrogen organic components that significantly affect the noble metal functioning. However, when Fischer-Tropsch products comprise higher concentrations of oxygenates utilizing a hydrocracking catalyst comprising base metal may be advantageous. So, yet in another embodiment a suitable hydrocracking catalyst comprises ASA, a crystalline acidic component and the aforementioned base metals. In some embodiment, the hydrocracking catalyst an acidic component that is only amorphous.

The hydrocracking reaction conditions include a temperature in the range of 315° C. to 415° C., and a pressure in the range of 300 to 1000 psig.

The hydrocracked effluent stream 120 from the hydrocracking reaction zone 110 and a steam stream 125 are sent to the product recovery zone 130. The product recovery zone 130 comprises one or more fractionation columns. The hydrocracked effluent stream 120 is separated into one or more product streams. For example, the product recovery zone 130 can produce at least a synthetic paraffinic kerosene stream 135 comprising C₈ to C₂₀ isoparaffins and normal paraffins, and an unconverted oil stream 140 comprising C₁₉₊ hydrocarbons. Additional streams can be produced, including, but not limited to, a hydrogen stream 145, a fuel gas stream 150 comprising fuel gas and liquefied petroleum gas, and a naphtha stream 155 comprising C₈₋ normal paraffins and isoparaffins. The hydrogen stream 145 can be combined with the hydrogen recycle stream 115. The renewable naphtha stream 155 has several dispositions. In one embodiment, the naphtha stream can be blended into a gasoline pool used for automotive fuel. The naphtha stream contains very low concentrations of aromatics, olefins, and sulfur. In another embodiment, the heavy naphtha stream can be utilized as a feed stream to thermal steam cracker and converted into olefins. In yet another embodiment, the heavy naphtha can be converted into a synthesis gas comprising carbon monoxide and hydrogen. In a further embodiment, the heavy naphtha can be burned as a fuel within the current invention in the reaction sections 110 or 160, or in the product recovery section 130 or in any combination thereof. Other separations could be performed as known to those of skill in the art.

The unconverted oil stream 140 is recycled to the hydrocracking reaction zone 110 and does not go to the dewaxing reaction zone 160.

The synthetic paraffinic kerosene stream 135 comprising C₈ to C₂₀ paraffins and isoparaffins and the hydrogen recycle stream 115 are sent to the dewaxing reaction zone 160 where a portion of the C₈ to C₂₀ normal paraffins are isomerized to C₈ to C₂₀ isoparaffins. Typically, greater than 50% of the normal paraffins are converted to isoparaffins, or greater than 60%, or greater than 70%, or greater than 80%, or greater than 90%.

The dewaxing reaction zone 160 comprises one or more dewaxing reactors.

The dewaxing reaction zone 160 contains a dewaxing catalyst. Any catalyst suitable for isomerizing the hydrocracked Fischer-Tropsch product stream can be used. One example of a suitable dewaxing catalyst comprises a noble metal and SAPO-11. Noble metals are described above. The catalyst is specific for renewable aviation and diesel applications, and it hydroisomerizes n-paraffins in diesel and kerosene carbon number ranges into iso-paraffins to meet cold flow property specifications, such as those found in ASTM D 7566. It has very high retention of C₈ to C₂₀ isoparaffins that produce diesel and SPK, very little naphtha generation, and it produces good cold flow properties.

The dewaxing reaction conditions include a temperature in the range of 315° C. to 400° C., and a pressure in the range of 300 psig to 1000 psig.

The dewaxed effluent stream 165 comprises synthetic paraffinic kerosene comprising C₈ to C₂₀ normal paraffins and isoparaffins.

Make up hydrogen stream 170 is combined with hydrogen recycle stream 215.

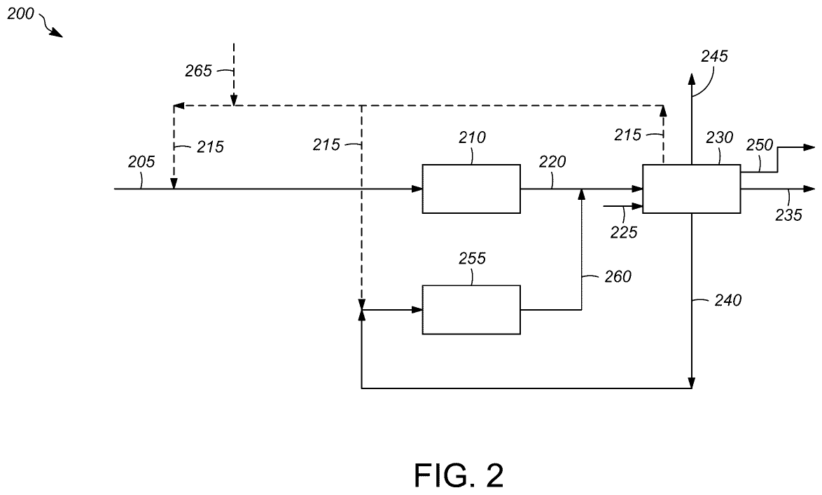

FIG. 2 illustrates a process 200 for upgrading Fischer-Tropsch oil to sustainable aviation fuel. The Fischer-Tropsch product stream 205 comprising C₈₊ normal paraffins is sent to the dewaxing reaction zone 210 along with a hydrogen recycle stream 215 where a portion of the normal paraffins is converted to isoparaffins.

The dewaxing effluent stream 220 and steam stream 225 are sent to the product recovery zone 230. The product recovery zone 230 comprises one or more fractionation columns. The dewaxing effluent stream 220 is separated into one or more product streams. For example, the product recovery zone 230 can produce at least a synthetic paraffinic kerosene stream 235 comprising C₈-C₁₈₊ normal and isoparaffins, and an unconverted oil stream 240 comprising C₁₉₊ paraffins. Additional streams can be produced, including, but not limited to, a hydrogen recycle stream 215, a fuel gas stream 245 comprising fuel gas and liquefied petroleum gas, and a renewable naphtha stream 250 comprising C₈₋ normal paraffins and isoparaffins. The hydrogen recycle stream 215 can be recycled to the dewaxing reaction zone 210 and/or the hydrocracking reaction zone 255. The renewable naphtha stream 155 has several dispositions. In one embodiment, the naphtha stream can be blended into a gasoline pool used for automotive fuel. The naphtha stream contains very low concentrations of aromatics, olefins, and sulfur. In another embodiment, the heavy naphtha stream can be utilized as a feed stream to thermal steam cracker and converted into olefins. In yet another embodiment, the heavy naphtha can be converted into a synthesis gas comprising carbon monoxide and hydrogen. In a further embodiment, the heavy naphtha can be burned as a fuel within the current invention in the reaction sections 110 or 160 or in the product recovery section 130 or in any combination thereof. Other separations could be performed as known to those of skill in the art.

The unconverted oil stream 240 is sent to a hydrocracking reaction zone 255 along with hydrogen recycle stream 215 where the C₁₉₊ normal paraffins and isoparaffins are hydrocracked to C₈₊ normal paraffins and isoparaffins.

The hydrocracking reaction zone 255 has multiple beds. The hydrocracking reaction zone 255 comprises one or more hydrocracking reactors, and each hydrocracking reactor can have one or more beds. A single hydrocracking reactor would have more than one bed. If there are two or more hydrocracking reactors, each reactor could have a single bed or multiple beds.

The hydrocracking reaction zone includes a hydrocracking catalyst. Any hydrocracking catalyst suitable for hydrocracking the Fischer-Tropsch product stream 205 can be used. One suitable hydrocracking catalyst comprises a noble metal and ASA which provides high selectivity of cracking the wax into renewable diesel and kerosene range carbon numbers. It is a good choice if the Fischer-Tropsch feed does not contain significant concentrations of sulfur or nitrogen. Suitable hydrocracking catalysts are described above.

The hydrocracking reaction conditions include a temperature in the range of 315° C. to 415° C., and a pressure in the range of 300 to 1000 psig.

The hydrocracked effluent stream 260 from the hydrocracking reaction zone 255, which comprises C₈₊ normal paraffins and isoparaffins, is sent to the product recovery zone 230.

Make up hydrogen stream 265 is combined with hydrogen recycle stream 215.

### SPECIFIC EMBODIMENTS

While the following is described in conjunction with specific embodiments, it will be understood that this description is intended to illustrate and not limit the scope of the preceding description and the appended claims.

A first embodiment of the invention is a process for upgrading Fischer-Tropsch oil to synthetic paraffinic kerosene comprising providing a Fischer-Tropsch product stream comprising C₈₊ normal paraffins; hydrocracking the Fischer-Tropsch product stream in a hydrocracking reaction zone comprising a hydrocracking reactor in the presence of a hydrocracking catalyst under hydrocracking conditions to form a hydrocracked effluent stream; separating the hydrocracked effluent stream in a product recovery zone into at least a synthetic paraffinic kerosene stream comprising C₈ to C₂₀ isoparaffins and normal paraffins, and an unconverted oil stream comprising C₁₉₊ hydrocarbons; dewaxing the synthetic paraffinic kerosene stream in a dewaxing reaction zone comprising a dewaxing reactor in the presence of a dewaxing catalyst under dewaxing conditions to form a Fischer-Tropsch synthetic paraffinic kerosene stream comprising C₈ to C₂₀ normal paraffins and isoparaffins. An embodiment of the invention is one, any or all of prior embodiments in this paragraph up through the first embodiment in this paragraph further comprising recycling the unconverted oil stream to the hydrocracking reaction zone. An embodiment of the invention is one, any or all of prior embodiments in this paragraph up through the first embodiment in this paragraph wherein separating the hydrocracked stream comprises separating the hydrocracked stream into at least the synthetic paraffinic kerosene stream, the unconverted oil stream, and a naphtha stream comprising C₈₋ normal paraffins and isoparaffins, or a fuel gas stream comprising fuel gas and liquified petroleum gas, or a hydrogen stream, or combinations thereof. An embodiment of the invention is one, any or all of prior embodiments in this paragraph up through the first embodiment in this paragraph further comprising passing a hydrogen gas stream to the dewaxing reaction zone or the hydocracking reaction zone or both. An embodiment of the invention is one, any or all of prior embodiments in this paragraph up through the first embodiment in this paragraph wherein the hydrogen gas stream comprises a recycle hydrogen stream from the product recovery zone. An embodiment of the invention is one, any or all of prior embodiments in this paragraph up through the first embodiment in this paragraph wherein the hydrocracking catalyst comprises an amorphous acidic component. An embodiment of the invention is one, any or all of prior embodiments in this paragraph up through the first embodiment in this paragraph wherein the amorphous acidic component comprises an amorphous silica-alumina. An embodiment of the invention is one, any or all of prior embodiments in this paragraph up through the first embodiment in this paragraph wherein the hydrocracking catalyst comprises a noble metal. An embodiment of the invention is one, any or all of prior embodiments in this paragraph up through the first embodiment in this paragraph wherein the dewaxing reaction conditions comprise a temperature in a range of 315° C. to 400° C., or a hydrogen partial pressure in a range of 300 psig to 1000 psig, or both; or the dewaxing catalyst comprises a molecular sieve of AEL or MRE framework with a noble metal; or both. An embodiment of the invention is one, any or all of prior embodiments in this paragraph up through the first embodiment in this paragraph wherein the hydrocracking reaction conditions comprise a temperature in a range of 315° C. to 415° C., or a pressure in a range of 300 to 1000 psig, or both; or the hydrocracking catalyst comprises Y zeolite, beta zeolite, amorphous silica-alumina, noble metals, base metals, or combinations thereof, or both. An embodiment of the invention is one, any or all of prior embodiments in this paragraph up through the first embodiment in this paragraph wherein providing the Fischer-Tropsch product stream comprises reacting synthesis gas comprising hydrogen and carbon monoxide or carbon dioxide or both in a Fischer-Tropsch reaction zone comprising a Fischer-Tropsch reactor in the presence of a Fischer-Tropsch catalyst under Fischer-Tropsch reaction conditions to form the Fischer-Tropsch product stream. An embodiment of the invention is one, any or all of prior embodiments in this paragraph up through the first embodiment in this paragraph wherein the Fischer-Tropsch reaction conditions comprise a temperature in a range of 150° C. to 300° C., or a pressure in a range of 200 to 750 psig, or both; or the Fischer-Tropsch catalyst comprises a Fe-, Co-, Ni-, Ru-based catalyst or combinations thereof, or both.

A second embodiment of the invention is a process for upgrading Fischer-Tropsch oil to synthetic paraffinic kerosene comprising providing a Fischer-Tropsch product stream comprising C₈₊ normal paraffins; dewaxing the Fischer-Tropsch product stream in a dewaxing reaction zone comprising a dewaxing reactor in the presence of a dewaxing catalyst under dewaxing conditions to form a dewaxed effluent stream comprising C₈₊ normal paraffins and isoparaffins; separating the dewaxed effluent stream and a hydrocracked effluent stream in a product recovery zone into at least a kerosene stream comprising C₈ to C₂₀ normal paraffins and isoparaffins, and an unconverted oil stream comprising C_{·+} hydrocarbons; hydrocracking the unconverted oil stream in a hydrocracking reaction zone comprising a hydrocracking reactor in the presence of a hydrocracking catalyst under hydrocracking conditions to form the hydrocracked effluent stream comprising C₈₊ normal paraffins and isoparaffins; and passing the hydrocracked effluent stream to the product recovery zone. An embodiment of the invention is one, any or all of prior embodiments in this paragraph up through the second embodiment in this paragraph wherein separating the dewaxed effluent stream and the hydrocracked effluent stream into at least the synthetic paraffinic kerosene stream and the unconverted oil stream comprises separating the dewaxed effluent stream and the hydrocracked effluent stream in the product recovery zone into at least the synthetic paraffinic kerosene stream, the unconverted oil stream, and a naphtha stream comprising C₈₋ normal paraffins and isoparaffins, or a fuel gas stream comprising fuel gas and liquefied petroleum gas, or a hydrogen stream, or combinations thereof. An embodiment of the invention is one, any or all of prior embodiments in this paragraph up through the second embodiment in this paragraph further comprising passing a hydrogen gas stream to the dewaxing reaction zone or the hydrocracking reaction zone or both. An embodiment of the invention is one, any or all of prior embodiments in this paragraph up through the second embodiment in this paragraph wherein the hydrogen gas stream comprises a recycle hydrogen stream from the product recovery zone. An embodiment of the invention is one, any or all of prior embodiments in this paragraph up through the second embodiment in this paragraph wherein the hydrocracking catalyst comprises an amorphous acidic component. An embodiment of the invention is one, any or all of prior embodiments in this paragraph up through the second embodiment in this paragraph wherein the amorphous acidic component comprises an amorphous silica-alumina. An embodiment of the invention is one, any or all of prior embodiments in this paragraph up through the second embodiment in this paragraph wherein the hydrocracking catalyst comprises a noble metal. An embodiment of the invention is one, any or all of prior embodiments in this paragraph up through the second embodiment in this paragraph wherein the dewaxing reaction conditions comprise a temperature in a range of 315° C. to 400° C., or a hydrogen partial pressure in a range of 300 psig to 1000 psig, or both; or the dewaxing catalyst comprises a molecular sieve of AEL or MRE framework with a noble metal; or both. An embodiment of the invention is one, any or all of prior embodiments in this paragraph up through the second embodiment in this paragraph wherein the hydrocracking reaction conditions comprise a temperature in a range of 315° C. to 415° C., or a pressure in a range of 300 to 1000 psig, or both; or the hydrocracking catalyst comprises Y zeolite, beta zeolite, amorphous silica-alumina, noble metals, base metals, or combinations thereof, or both. An embodiment of the invention is one, any or all of prior embodiments in this paragraph up through the second embodiment in this paragraph wherein providing the Fischer-Tropsch product stream comprises reacting synthesis gas comprising hydrogen and carbon monoxide or carbon dioxide or both in a Fischer-Tropsch reaction zone comprising a Fischer-Tropsch reactor in the presence of a Fischer-Tropsch catalyst under Fischer-Tropsch reaction conditions to form the Fischer-Tropsch product stream. An embodiment of the invention is one, any or all of prior embodiments in this paragraph up through the second embodiment in this paragraph wherein the Fischer-Tropsch reaction conditions comprise a temperature in a range of 150° C. to 300° C., or a pressure in a range of 200 to 750 psig, or both; or the Fischer-Tropsch catalyst comprises a Fe-, Co-, Ni-, Ru-based catalyst or combinations thereof, or both.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for upgrading Fischer-Tropsch oil to synthetic paraffinic kerosene comprising:
providing a Fischer-Tropsch product stream comprising C₈₊ normal paraffins;
hydrocracking the Fischer-Tropsch product stream in a hydrocracking reaction zone comprising a hydrocracking reactor in the presence of a hydrocracking catalyst under hydrocracking conditions to form a hydrocracked effluent stream;
separating the hydrocracked effluent stream in a product recovery zone into at least a kerosene stream comprising C₈ to C₂₀ isoparaffins and normal paraffins, and an unconverted oil stream comprising C₁₉₊ hydrocarbons; and
dewaxing the kerosene stream in a dewaxing reaction zone comprising a dewaxing reactor in the presence of a dewaxing catalyst under dewaxing conditions to form a synthetic paraffinic kerosene stream comprising C₈ to C₂₀ normal paraffins and isoparaffins.

2. The process of claim 1 further comprising:
recycling the unconverted oil stream to the hydrocracking reaction zone.

3. The process of claim 1 wherein separating the hydrocracked effluent stream comprises separating the hydrocracked effluent stream into at least the synthetic paraffinic kerosene stream, the unconverted oil stream, and a naphtha stream comprising C₈₋ normal paraffins and isoparaffins, or a fuel gas stream comprising fuel gas and liquified petroleum gas, or a hydrogen stream, or combinations thereof.

4. The process of claim 1 further comprising:
passing a hydrogen gas stream to the dewaxing reaction zone or the hydocracking reaction zone or both.

5. The process of claim 4 wherein the hydrogen gas stream comprises a recycle hydrogen stream from the product recovery zone.

6. The process of claim 1 wherein the hydrocracking catalyst comprises an amorphous acidic component.

7. The process of claim 6 wherein the amorphous acidic component comprises an amorphous silica-alumina.

8. The process of claim 1 wherein the hydrocracking catalyst comprises a noble metal.

9. The process of claim 1 wherein:
the dewaxing reaction conditions comprise a temperature in a range of 315° C. to 400° C., or a hydrogen partial pressure in a range of 300 psig to 1000 psig, or both; or
the dewaxing catalyst comprises a molecular sieve of AEL or MRE framework with a noble metal;
or both.

10. The process of claim 1 wherein:
the hydrocracking reaction conditions comprise a temperature in a range of 315° C. to 415° C., or a pressure in a range of 300 to 1000 psig, or both; or
the hydrocracking catalyst comprises Y zeolite, beta zeolite, amorphous silica-alumina, noble metals, base metals, or combinations thereof,
or both.

11. The process of claim 1 wherein providing the Fischer-Tropsch product stream comprises:
reacting synthesis gas comprising hydrogen and carbon monoxide or carbon dioxide or both in a Fischer-Tropsch reaction zone comprising a Fischer-Tropsch reactor in the presence of a Fischer-Tropsch catalyst under Fischer-Tropsch reaction conditions to form the Fischer-Tropsch product stream;
wherein:
the Fischer-Tropsch reaction conditions comprise a temperature in a range of 150° C. to 300° C., or a pressure in a range of 200 to 750 psig, or both; or
the Fischer-Tropsch catalyst comprises a Fe-, Co-, Ni-, Ru-based catalyst or combinations thereof,
or both.

12. A process for upgrading Fischer-Tropsch oil to synthetic paraffinic kerosene comprising:
providing a Fischer-Tropsch product stream comprising C₈₊ normal paraffins;
dewaxing the Fischer-Tropsch product stream in a dewaxing reaction zone comprising a dewaxing reactor in the presence of a dewaxing catalyst under dewaxing conditions to form a dewaxed effluent stream comprising C₈₊ normal paraffins and isoparaffins;
separating the dewaxed effluent stream and a hydrocracked effluent stream in a product recovery zone into at least a synthetic paraffinic kerosene stream comprising C₈ to C₂₀ normal paraffins and isoparaffins, and an unconverted oil stream comprising C₁₉₊ hydrocarbons;
hydrocracking the unconverted oil stream in a hydrocracking reaction zone comprising a hydrocracking reactor in the presence of a hydrocracking catalyst under hydrocracking conditions to form the hydrocracked effluent stream comprising C₈₊ normal paraffins and isoparaffins; and
passing the hydrocracked effluent stream to the product recovery zone.

13. The process of claim 12 wherein separating the dewaxed effluent stream and the hydrocracked effluent stream into at least the synthetic paraffinic kerosene stream and the unconverted oil stream comprises separating the dewaxed effluent stream and the hydrocracked effluent stream in the product recovery zone into at least the synthetic paraffinic kerosene stream, the unconverted oil stream, and a naphtha stream comprising C₈₋ normal paraffins and isoparaffins, or a fuel gas stream comprising fuel gas and liquefied petroleum gas, or a hydrogen stream, or combinations thereof.

14. The process of claim 12 further comprising:
passing a hydrogen gas stream to the dewaxing reaction zone or the hydrocracking reaction zone or both.

15. The process of claim 14 wherein the hydrogen gas stream comprises a recycle hydrogen stream from the product recovery zone.

16. The process of claim 12 wherein the hydrocracking catalyst comprises an amorphous acidic component.

17. The process of claim 16 wherein the amorphous acidic component comprises an amorphous silica-alumina.

18. The process of claim 12 wherein the hydrocracking catalyst comprises a noble metal.

19. The process of claim 12 wherein:
the dewaxing reaction conditions comprise a temperature in a range of 315° C. to 400° C., or a hydrogen partial pressure in a range of 300 psig to 1000 psig, or both; or
the dewaxing catalyst comprises a molecular sieve of AEL or MRE framework with a noble metal;
or both;
wherein:
the hydrocracking reaction conditions comprise a temperature in a range of 315° C. to 415° C., or a pressure in a range of 300 to 1000 psig, or both; or
the hydrocracking catalyst comprises Y zeolite, beta zeolite, amorphous silica-alumina, noble metals, base metals, or combinations thereof,
or both.

20. The process of claim 12 wherein providing the Fischer-Tropsch product stream comprises:
reacting synthesis gas comprising hydrogen and carbon monoxide or carbon dioxide or both in a Fischer-Tropsch reaction zone comprising a Fischer-Tropsch reactor in the presence of a Fischer-Tropsch catalyst under Fischer-Tropsch reaction conditions to form the Fischer-Tropsch product stream;
wherein:
the Fischer-Tropsch reaction conditions comprise a temperature in a range of 150° C. to 300° C., or a pressure in a range of 200 to 750 psig, or both; or
the Fischer-Tropsch catalyst comprises a Fe-, Co-, Ni-, Ru-based catalyst or combinations thereof,
or both.
